(19) United States
(12) Patent Application Publication
(10) Pub. No.: US 2022/0374948 A1
(43) Pub. Date: Nov. 24, 2022

(54) ACTIVE BLOCKCHAIN MICRO-TRACKING SYSTEM FOR AUTOMATIC ALLOCATION AND DISTRIBUTION OF DONATIONS AND METHOD THEREOF

(71) Applicant: E4NET CO., LTD, Seoul (KR)

(72) Inventor: Su jeong Lee, Seoul (KR)

(21) Appl. No.: 17/574,567

(22) Filed: Jan. 13, 2022

(30) Foreign Application Priority Data
May 18, 2021 (KR) 10-2021-0064124

(51) Int. Cl. G06Q 30/02; G06Q 20/38; G06Q 20/36; G06Q 20/06; G06Q 20/22

(52) U.S. Cl. CPC G06Q 30/0279; G06Q 20/38215; G06Q 20/3674; G06Q 20/065; G06Q 20/3827; G06Q 20/223

(57) ABSTRACT

Disclosed are an active blockchain micro-tracking system for automatic allocation and distribution of donations and a method thereof. The active blockchain micro-tracking system for the automatic allocation and distribution of donations comprises: a donor terminal which makes donations; a donations manager terminal which designates the distribution of the donations; a donation execution server which executes the donation, which is donated by the donor terminal, in accordance with the distribution designated by the donations manager terminal thereby providing a benefit amount; and a beneficiary terminal which receives the benefit amount from the donation execution server and uses the benefit amount.

### CROSS-REFERENCE TO RELATED APPLICATIONS

This application claims priority under 35 U.S.C § 119 to Korean Patent Application No. 10-2021-0064124 filed in the Korean Intellectual Property Office on May 18, 2021, the entire contents of which are hereby incorporated by reference.

### TECHNICAL FIELD

The present invention relates to a donation tracking system and a method thereof. More specifically, the present invention relates to an active blockchain micro-tracking system for automatic allocation and distribution of donations and a method thereof.

### BACKGROUND

When a donor donates to a charity group, the donor in many cases cannot precisely identify how the donations are used. In addition, even when the donor learns where the donations were made, their use remains a mystery—were they given to the originally described recipient? Or were they distributed elsewhere?

Donors are now demanding that their questions be addressed and that their donations be tracked until final use.

However, there has been no means of detecting issues including the omission or theft of donations, so a system of tracking that accurately maps the movement of donations and confirms where the donations are ultimately used is needed.

### SUMMARY

The purpose of the present invention is to provide an active blockchain micro-tracking system for automatic allocation and distribution of donations.

Another purpose of the present invention is to provide an active blockchain micro-tracking method for automatic allocation and distribution of donations.

According to the first purpose of the present invention, the active blockchain micro-tracking system for automatic allocation and distribution of donations comprises: a donor terminal which makes donations; a donation manager terminal which designates the distribution of the donations; and a donation execution server which executes donations in accordance with the distribution designated by the donations manager terminal for the donations made by the donor terminal and provides the benefit amount.

Here, the active blockchain micro-tracking system for the automatic allocation and distribution of donations additionally comprises a beneficiary terminal which receives and uses the benefit amount from the donation execution server.

As such, according to the other purpose of the present invention, the active blockchain micro-tracking method by automatic allocation and distribution of donations comprises: a step in which the donor terminal makes donations; a step in which the donation manager terminal designates the donations; and a step in which the donation execution server allocates the donations as funds in accordance with the automatic allocation for the funds determined by the donor terminal, and in which a donation distribution module provides the benefit amount to the beneficiary terminal in accordance with the automatic distribution.

Here, the active blockchain micro-tracking method for automatic allocation and distribution of donations additionally comprises a step in which the beneficiary terminal receives and uses the benefit amount from the donation execution server.

According to the active blockchain micro-tracking system for automatic allocation and distribution of donations and the method thereof, the system and the method are configured to precisely map the beneficiary and the benefit amount of the donations by a first-in-first-out manner as well as by dividing the donations into units of a certain small amount, thereby providing effects in which the donor can learn specifically about which beneficiary receives his/her donations.

In addition, the system and the method are configured to map the donations, benefit amount, usage, and used amount into a unit of a certain small amount, to track the usage of the benefit amount, and to prevent the donations from being stolen or illegally used.

Ultimately, the transparency of the donations is secured and the donation can be made with confidence that the intended beneficiary is the actual recipient.

### BRIEF DESCRIPTION OF THE DRAWING

FIG. 1 is a block diagram of the active blockchain micro-tracking system for automatic allocation and distribution of donations according to an embodiment of the present invention.

2 is a schematic diagram of the method for automatic allocation and distribution of donations according to an embodiment of the present invention.

FIG. 3 is a flowchart of the active blockchain micro-tracking method for automatic allocation and distribution of donations according to an embodiment of the present invention.

FIG. 4 is an example of tracking the history of donations by micro-tracking from the perspective of the donor, so various amounts can be automatically allocated, distributed, and micro-tracked.

### DETAILED DESCRIPTION

The present invention is capable of having various applications and a plurality of embodiments and is to present specific embodiments on the drawings and to describe the specific details for implementing the present invention. However, this is not to limit the present invention to a specific embodiment, and it must be understood to include all variations, equivalents, and alternatives included in the idea and technological scope of the present invention. Similar reference symbols are used for similar components in descriptions of each of the drawings.

The terminology such as First, Second, A, and B are used to describe various components, but the components must not be limited by the terminology. The terminology is used only for distinguishing a single component from other components. For example, the first component can be named as the second component without exceeding the scope of the claims of the present invention, and similarly, the second component can also be named as the first component. The terminology of “and/or” includes a combination of a plurality of relevant, described items or an item of the plurality of relevant, described items.

When a certain component is mentioned to be “connected” to or “accessed” another component, the component may be directly connected to or accessed from the other component, but it should be understood that there may be an intermediate component. On the other hand, when a component is mentioned to be “directly connected” to or “directly accessed” from another, it should be understood that there is no other component in the middle.

The terminology used in the present invention is not intended to limit the present invention but to describe specific embodiments. Singular expressions also convey the meaning of plural unless it is clearly meant to be different in the context. In the present invention, terminology such as “comprise” or “have” should be understood to be intended to designate that there exist the characteristics, numbers, steps, operations, components, parts, or combinations thereof, not to be intended to exclude in advance the existence of any other one or more characteristics, numbers, steps, operations, components, parts, or combinations thereof or their possibility of being added.

Unless defined otherwise, all terminology used herein including technological or scientific terminology has the same significance as the general understanding by any person with ordinary knowledge in the technical field to which the present invention belongs. Terminology defined in the dictionaries used in general should be interpreted as having the same significance as that of the relevant technologies in the context, and unless they are clearly defined in the present invention, they are not interpreted as having an ideal or excessively formal significance.

Hereinafter, a desirable embodiment according to the present invention is described in detail with reference to the attached drawings.

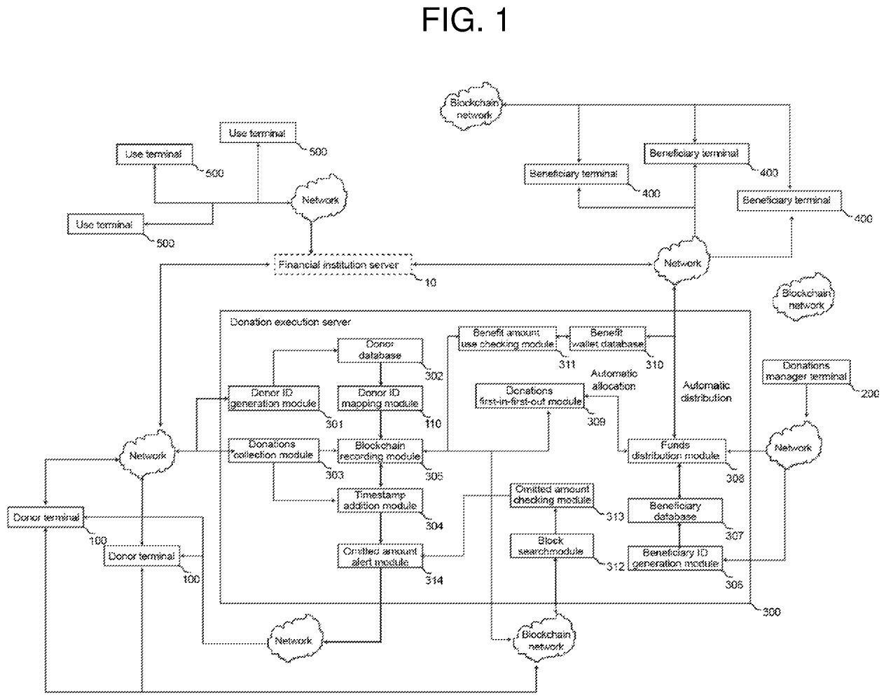

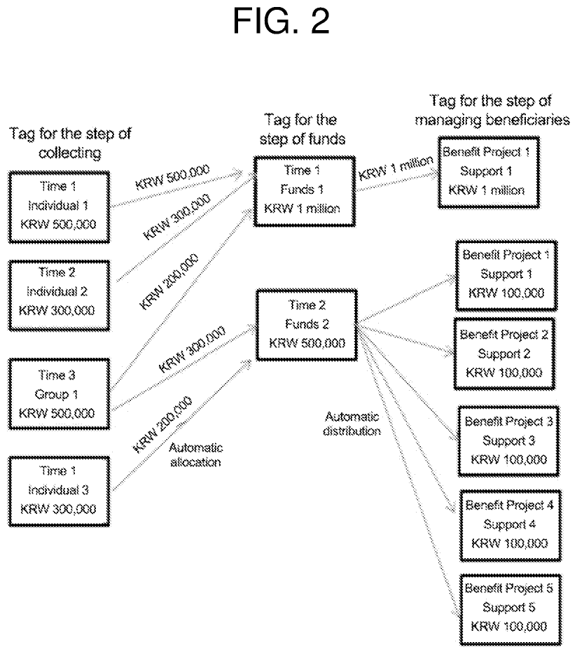

FIG. 1 is a block diagram of the active blockchain micro-tracking system for automatic allocation and distribution of donations in accordance with an embodiment of the present invention, and FIG. 2 is a schematic diagram of the method for automatic allocation and distribution of donations in accordance with an embodiment of the present invention.

As seen in FIG. 1, the active blockchain micro-tracking system for automatic allocation and distribution of donations according to an embodiment of the present invention comprises a donor terminal (100), a donation manager terminal (200), a donation execution server (300), a. beneficiary terminal (400), and a use terminal (500).

Hereinafter described is the detailed configuration.

The donor terminal (100) is configured to make donations.

The donation manager terminal (200) is configured to designate a beneficiary.

The donation execution server (300) is configured to provide the benefit amount by executing the donation to the beneficiary designated by the donation manager terminal (200) for the donations made by the donor terminal (100).

The donation execution server (300) comprises: a donor ID generation module (301); a donor database (302); a donations collection module (303); a timestamp addition module (304); a blockchain recording module (305); a beneficiary ID generation module (306); a beneficiary database (307); a funds distribution module (308); a donations first-in-first-out module (309); a benefit wallet database (310); a benefit amount use checking module (311); a block search module (312); an omitted amount checking module (313); and an omitted amount alert module (314).

Hereinafter described is the detailed configuration.

The donor ID generation module (301) is configured to generate a donor ID of the donor terminal (100). The donor 117 generation module (301) generates a donor ID in accordance with the request of the donor terminal (100) and provides the donor ID to the donor terminal (100). In addition, a tag, of the donor ID is added to the donations for notifying who has made the donations.

The donor database (302) is configured to store the donor ID generated by the donor 117 generation module (301).

The donations collection module (303) is configured to collect the donations made by the donor ID stored in the donor database (302) from the donor terminal (100). The donations collection module (303) can collect donations through a financial institution server (10). On top of that, the donations collection module (303) can collect actual articles such as drinking water and ramen.

The timestamp addition module (304) is configured to add a timestamp for a unit of a certain amount in accordance with the sequence of collecting donations for the donations collected by the donations collection module (303),

Here, the timestamp can be generated based on the sequence of donation of the donations or the current time. In addition, a unit of a certain amount can be the minimum unit of using the donations such as KRW 1,000 or KRW 10,000.

For instance, when a donor makes a donation of KRW 1 million arid the minimum unit of amount for adding the timestamp is KRW 10,000, the donation of KRW 1 million is divided into 100 minimum units of amount, and 100 timestamps are generated, respectively, and a timestamp can be added to each of the 100 units of KRW 10,000.

The 100 timestamps can have the information of the same time of donation, and each of the 100 timestamps can additionally include a unique serial number ranging from one through 100. Here, each unit of KRW 10,000 of the donation has its unique timestamp.

Each unit of KRW 10,000 is the least amount for providing the donations to a beneficiary. Each unit of KRW 10,000 can be tracked, thereby providing information about when, how, and for what usage the donations are provided to which beneficiary. As seen in FIG. 2, the donations and the benefit amount are mapped for each unit of a certain amount.

If the donations are actual articles such as drinking water, the unit of donation may be determined to be one pack or one bottle of drinking water,

Meanwhile, the unit of a certain amount can be variably set in accordance with the beneficiary, characteristics of the beneficiary, the details of benefits, etc. The unit of a certain amount can be variably determined by the control of the control module, and also be variably set in accordance with the distribution of donations by the funds distribution module (308), that is, a plan for providing the benefit amount.

The blockchain recording module (305) is configured to add the donor ID and the timestamp for each unit of a certain amount of the donations collected by the donations collection module (303) and to record the information on the blockchain.

The beneficiary ID generation module (306) is configured to generate a beneficiary ID in accordance with an input by the donations manager terminal (200). The beneficiary may be a group of people or an individual,

The beneficiary database (307) is configured to store the beneficiary If) generated by the beneficiary ID generation module (306).

The funds distribution module (308) is configured to execute the allocation of the donations in accordance with the input of the donations manager terminal (200) as funds to the beneficiary of the beneficiary ID stored in the beneficiary database (307) and to provide a certain benefit amount.

The donations first-in-first-out module (309) is configured to perform the first-in-first-out process for each unit of a certain amount so that the funds' distribution module (308) can automatically allocate the donations distributed by the funds' distribution module (308) in accordance with the sequence of collection and to provide the funds thereby. As described above, the donations' first-in-first-out module (309) is configured to perform the first-in-first-out process for the unit of a certain amount of the donation in accordance with the sequence of the timestamps so that the donations of the timestamps which have been deposited earlier are to be automatically allocated as the funds formed in accordance with the sequence through the first-in-first-out process. Accordingly, the configuration allows both the donations and the funds to be automatically allocated by the first-in-first-out process. When the donations and the funds are automatically allocated in the blockchain system, the donations of a specific donor may be used for various funds by being divided, not being used for just a single specific fund, in accordance with the first-in-first-out process.

The amount formed into the funds is automatically allocated in the first-in-first-out manner when being distributed to the beneficiaries as well.

When a separate fund formation is not necessary in accordance with the characteristics of donations, and when the benefit amount is directly given to the beneficiary without going through the step of automatic allocation, the benefit amount is also transferred to the donations and the beneficiary by the automatic distribution of the first-in-first-out process and all circumstances can be micro-tracked.

The benefit wallet database (310) is configured to store the benefit amount provided by the funds distribution module (308) for each beneficiary M. The benefit amount can be stored for each beneficiary ID and used via the financial institution server (10).

The benefit amount use checking module (311) is configured to check the use of the benefit amount for each beneficiary ID and each unit of a certain amount by referring to the benefit wallet database (310). The benefit amount use checking module (311) is configured so that, as the beneficiary terminal (400) uses the benefit amount, the benefit amount of the beneficiary ID can be changed and stored in the benefit wallet database (310),

The block search module (312) is configured to search each block of the blockchain. That is, the block search module (312) is configured to search and monitor all of the donations, donor ID, benefit amount, beneficiary ID, beneficiary wallet, usage, etc.

The omitted amount checking module (313) is configured to check the omission of the distribution of donations and the omission of the use of the benefit amount from each block searched by the block search module (312) and to check the omitted amount. That is, when the donations of the timestamps of a specific section are not mapped on the beneficiary and the benefit amount and are not designated, the omitted amount checking module (313) can check the amount and also check if the benefit amount is not used within a certain period although the benefit amount is stored in the benefit wallet. As such, the omitted amount checking module (313) can check the amount omitted in the benefit, usage, etc.

The omitted amount alert module (314) is configured to transmit an alert on the information about the omitted distribution of the donations, the omitted use of the benefit amount, and the omitted amount checked by the omitted amount checking module (313) to the donor terminal (100) in real time. The donor can learn that his/her donations are omitted and not provided to any beneficiary via the module and ask the charity group to have the benefit amount provided or used.

That is, the active blockchain micro-tracking system provides a micro-tracking function to track not only the detailed status of the use of donations but also the omission and theft of the donations, which are accordingly provided to an illegal beneficiary or used for illegal purposes, so that all his/her donations are lawfully used.

The beneficiary terminal (400) is configured to receive the benefit amount from the donation execution server (300) and to use the benefit amount.

Meanwhile, the block search module (312) can provide the beneficiary terminal (400) with the information collected by searching and monitoring the blocks, and the beneficiary terminal (400) can check which donor has donated his/her benefit amount

The usage terminal (500) is for the usage of the benefit amount and is configured to allow the benefit amount to be used by the beneficiary terminal (400). The usage is what the beneficiary intends to use the benefit amount for and is allowed to not be designated in advance. The beneficiary terminal (400) can precisely leave the records of the usage and whether the benefit amount is used or not by recording the receipt of the usage or the like on the blockchain and receiving the receipt from the use terminal (500).

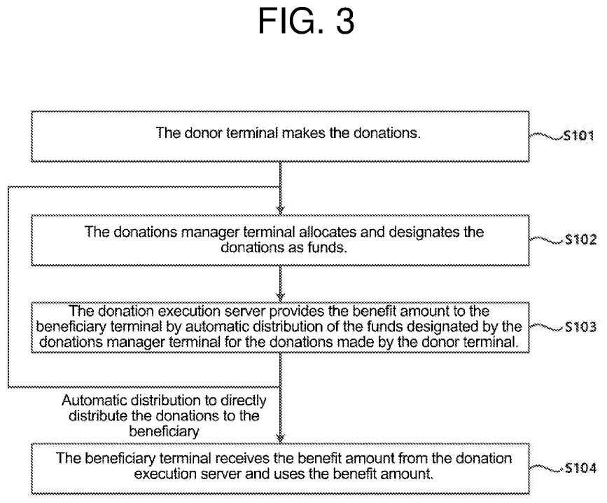

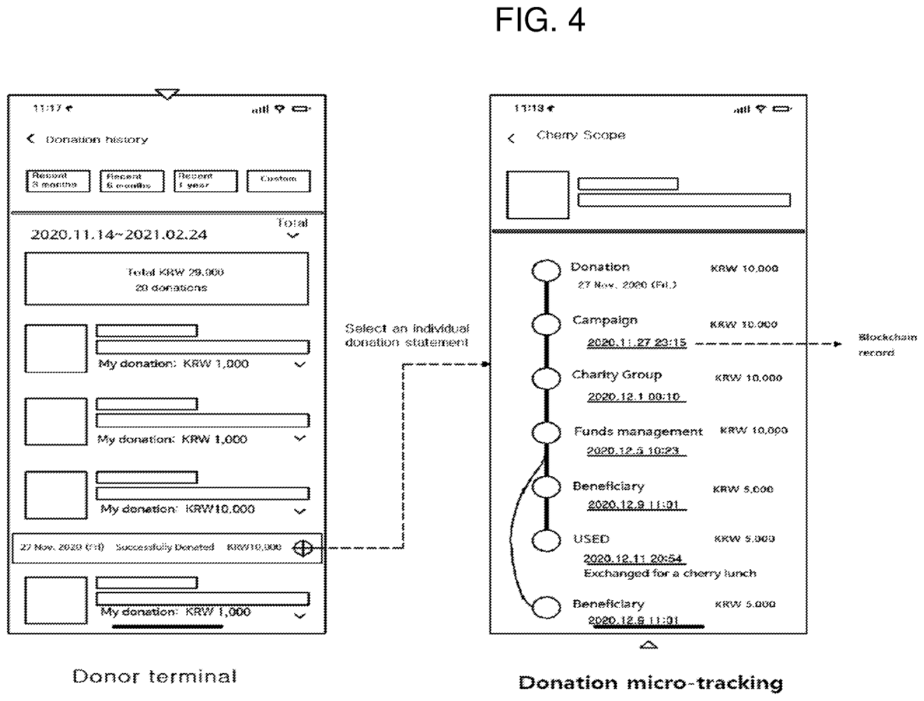

FIG. 3 is a flowchart of the active blockchain micro-tracking method by automatic allocation and distribution of donations according to an embodiment of the present invention.

In FIG. 3, firstly, the donor terminal (100) makes the donations (S101).

Next, the donations manager terminal (200) designates the distribution of the donations (S102).

Next, the donation execution server (300) forms the funds designated by the donations manager terminal (200) with the donations donated by the donor terminal (100) in accordance with automatic allocation and provides the beneficiary terminal (400) with the benefit amount as determined from among the funds by automatic distribution (S103).

Next, the beneficiary terminal (400) receives the benefit amount from the donation execution server (300) and uses the benefit amount (S104),

Although the present invention is described with reference to the embodiments as above, anyone who is skilled in the relevant field may well understand that the present invention can be variously modified and changed within a range which does not exceed the idea and areas of the present invention written in the scope of claim below.

What is claimed is:

1. An active blockchain micro-tracking system for automatic allocation and distribution of donations, comprising:
a donor terminal (100) which makes donations;
a donations manager terminal which designates the beneficiary;
a donation execution server which provides a benefit amount by executing the donation to the beneficiary designated by the donations manager terminal for the donations made by the donor terminal;
a beneficiary terminal which receives the benefit amount from the donation execution server and uses the benefit amount: and
a use terminal of usage of the benefit amount by the beneficiary terminal,
wherein the donation execution server includes:
a donor ID generation module which generates a donor ID of the donor terminal;
a donor database which stores the donor ID generated by the donor ID generation module;
a donations collection module which collects the donations by the donor ID stored in the donor database from the donor terminal;
a timestamp addition module which adds a timestamp for each unit of a certain amount in accordance with the sequence of collection for the donations collected by the donations collection module;
a blockchain recording module which adds the donor ID and the timestamp for each unit of a certain amount of the donations collected by the donations collection module and records the information on the blockchain;
a beneficiary ID generation module which generates a beneficiary ID in accordance with an input of the donations manager terminal;
a beneficiary database which stores the beneficiary ID generated by the beneficiary ID generation module;
a donations distribution module which distributes the donations in accordance with the input of the donations manager terminal to the beneficiary of the beneficiary ID stored in the beneficiary database and provides a certain benefit amount;
a donations first-in-first-out module which performs a first-in-first-out process tier each unit of a certain amount so that the benefit amount can be distributed provided by the donations distribution module in accordance with the sequence of collecting the donations;
a benefit wallet database which stores the benefit amount provided by the donations distribution module for each beneficiary a benefit amount use checking module which refers to the benefit wallet database and checks the use of the benefit amount for each beneficiary ID and each unit of a certain amount;
a block search module which searches each block of the blockchain;
an omitted amount checking module (313) which checks the omission of distribution and the omission of use of the benefit amount from each block searched by the block search module, and checks the omitted amount; and
an omitted amount alert module which transmits an alert on the information of the omitted distribution of the donations, the omitted use of the benefit amount, and the omitted amount checked by the omitted amount checking module to the donor terminal in real time,
wherein the blockchain recording module is configured to record the benefit amount which is first-in and first-out for each unit of a certain amount by the donations first-in-first-out module along with the beneficiary ID on the blockchain,
the blockchain recording module is configured to record the use of the benefit amount checked by the benefit amount use checking module along with the beneficiary ID on the blockchain,
the omitted amount checking module checks if the benefit amount is not used within a predetermined period although the benefit amount is stored in the benefit wallet database, the omitted amount alert module is configured to, when the benefit amount is not used within the specified period, transmit an alert on the omitted amount to the donor terminal in real time,
the use terminal transmits the receipt to the beneficiary terminal of the beneficiary who has used the benefit amount for the usage, and
the beneficiary terminal is configured to receive the receipt from the use terminal and to record the usage and whether the benefit amount is used or not on the blockchain by using the received receipt.
